(19) United States
(12) Patent Application Publication
(10) Pub. No.: US 2026/0195917 A1
(43) Pub. Date: Jul. 9, 2026

(54) OBJECT DETECTION METHOD AND COMPUTING SYSTEM THEREOF

(71) Applicant: Augentix Inc., Hsinchu City (TW)

(72) Inventor: Fang-Chen Chang, Tainan City (TW)

(73) Assignee: Augentix Inc., Hsinchu City (TW)

(21) Appl. No.: 19/074,425

(22) Filed: Mar. 9, 2025

(30) Foreign Application Priority Data
Jan. 8, 2025 (TW) 114100709

(51) Int. Cl. G06T 7/70; G06T 7/20

(52) U.S. Cl. CPC G06T 7/70; G06T 7/20

(57) ABSTRACT

An object detection method, for an image capturing device includes receiving a plurality of frames from the image capturing device; calculating a background speed and a foreground speed of an object in a current frame of the plurality of frames, when detecting a motion signal of the image capturing device; and determining an object position of the object in the current frame according to the background speed, the foreground speed of the object in the current frame and a previous object position of the object in a previous frame.

### BACKGROUND OF THE INVENTION

### 1. Field of the Invention

The present invention relates to an object detection method and a computing system thereof, and more particularly, to an object detection method and a computing system capable of improving an accuracy of the object detection.

### 2. Description of the Prior Art

With the development of technology, all kinds of cameras and related devices are provided. The captured images or videos taken by the image/video capturing devices may be utilized for tracking objects, e.g. humans or vehicles. When the image capturing device performs the object tracking, the image capturing device may be moved by external forces, e.g., when the camera of the image capturing device is moved by wind, a moving speed of the frame of the image capturing device is non-zero.

Since the object tracking is related to the background

moving speed and the depth of field (DOF), when the moving speed of the captured image frame is not zero, the object in the frame is hard to be separated, such that the characters of the object or the background cannot be precisely distinguished, which affects the object tracking function.

Therefore, improvements are necessary to the conventional techniques.

### SUMMARY OF THE INVENTION

In light of this, the present invention provides an object detection method and a computing system thereof to improve the accuracy of object detection and the disadvantages of the conventional techniques are improved.

An embodiment of the present invention discloses an object detection method, for an image capturing device comprises receiving a plurality of frames from the image capturing device; calculating a background speed and a foreground speed of an object in a current frame of the plurality of frames, when detecting a motion signal of the image capturing device; and determining an object position of the object in the current frame according to the background speed, the foreground speed of the object in the current frame and a previous object position of the object in a previous frame.

Another embodiment of the present invention discloses A computer system, comprises a processing device; and a memory device coupled to the processing device, for storing a program code instructing the processing device to perform an object detection process in a video, wherein the object detection process comprises receiving a plurality of frames from the image capturing device; calculating a background speed and a foreground speed of an object in a current frame of the plurality of frames, when detecting a motion signal of the image capturing device; and determining an object position of the object in the current frame according to the background speed, the foreground speed of the object in the current frame and a previous object position of the object in a previous frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an object detection process according to an embodiment of the present invention.

FIG. 2 is a schematic diagram of calculating a background speed according to an embodiment of the present invention.

FIG. 3 is a schematic diagram of updating an object position according to an embodiment of the present invention.

FIG. 4 is a schematic diagram of a computer system according to an example of the present invention.

### DETAILED DESCRIPTION

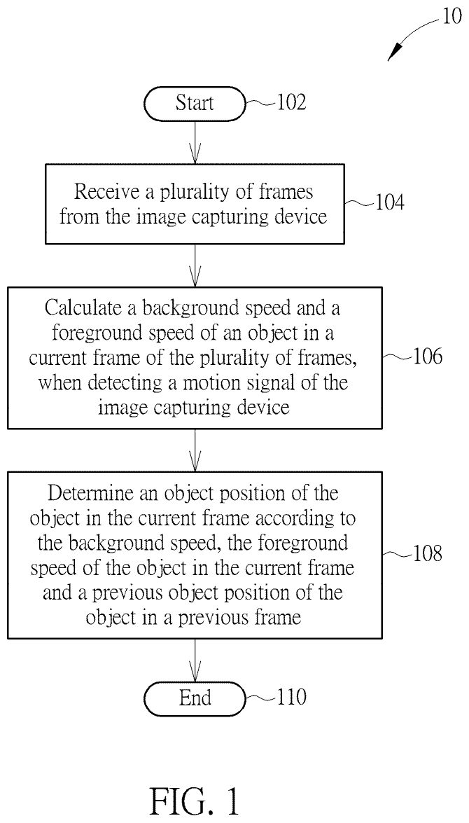

Please refer to FIG. 1, which is a schematic diagram of an object detection process 10 according to an embodiment of the present invention. The object detection process 10 according to an embodiment of the present invention may be utilized on an image capturing device for detecting objects in the images taken by the image capturing device, e.g., pedestrians, cars or faces of the images. The object detection process 10 includes the following steps:
Step 102: Start.
Step 104: Receive a plurality of frames from the image capturing device;
Step 106: Calculate a background speed and a foreground speed of an object in a current frame of the plurality of frames, when detecting a motion signal of the image capturing device;
Step 108: Determine an object position of the object in the current frame according to the background speed, the foreground speed of the object in the current frame and a previous object position of the object in a previous frame;
Step 110: End.

Since the image capturing device is usually mounted on a tripod head, which connects to the bottom of the image capturing device via a steering shaft, when external force, e.g., wind, vibration, movement, rotation or other factors, is exerted on the tripod head, the frames captured by the image capturing device are moved, which affects the efficiency of the object tracking. The object detection process 10 according to an embodiment of the present invention may improve the accuracy of the object tracking according to related information of the frames of the image capturing device.

The frames captured by the image capturing device are

received in step 104. In step 106, when the motion signal of the image capturing device is detected, the background speed and the foreground speed of the object in the current frame are calculated. The motion signal of the image capturing device may be internally generated by the image capturing device, or the motion signal may be generated by a processing device connected to the image capturing device. When the motion signal is generated or the processing device connected to the image capturing device receives the motion signal from the image capturing device, a frame moving of the image capturing device is detected.

For example, the image capturing device may include a rotation motor connected to the tripod head, wherein the rotation motor is utilized for rotating the image capturing device. When the rotation motor works, a rotation signal is generated, and then the image capturing device or the processing device may generate the motion signal according to the rotation signal. In other words, the image capturing device or the processing device may determine the frame moving of the image capturing device according to the rotation signal when the image capturing device rotates.

The above embodiments of detecting the frame moving of the image capturing device are determined by the signal generated by the image capturing device. In another embodiment, a moving confidence value may be utilized for determining whether the frame of the image capturing device is moved or not.

In detail, the image capturing device according to an embodiment of the present invention may determine whether to generate the motion signal or not according to a moving count value of a plurality of moving blocks of the current frame when the image capturing device is still. The image capturing device may calculate the moving count value of the current frame according to a counting value of the moving blocks of the object in the current frame and a distance between the object and the image capturing device, wherein the moving count value may be a basis for determining whether the image capturing device is moved or not.

More specifically, the moving confidence value may be a ratio of the moving count value of the current frame to a plurality of blocks of the current frame so as to determine whether the image capturing device is moved or not. That is, the current frame includes moving blocks and non-moving blocks, when a proportion of the moving blocks is larger than a threshold of all blocks, the moving confidence value is larger. Therefore, the ratio may be a basis for determining whether the image capturing device is moved or not.

On the other hand, the present invention may determine the moving confidence value according to a difference of the moving count value of the moving blocks of the current frame and a previous moving count value of the moving blocks of the previous frame. In other words, when a difference between the moving count value of the moving blocks of the current frame and the previous moving count value of the moving blocks is larger than a threshold, the moving confidence value is larger. Therefore, the ratio may be a basis for determining whether the image capturing device is moved or not.

In another embodiment, the present invention determines the moving confidence value with the above methods, the moving confidence value is quantified and a larger moving confidence value is selected as a bases for determining whether the image capturing device is moved or not. Alternatively, in another embodiment, both methods may be incorporated to determine corresponding moving confidence value.

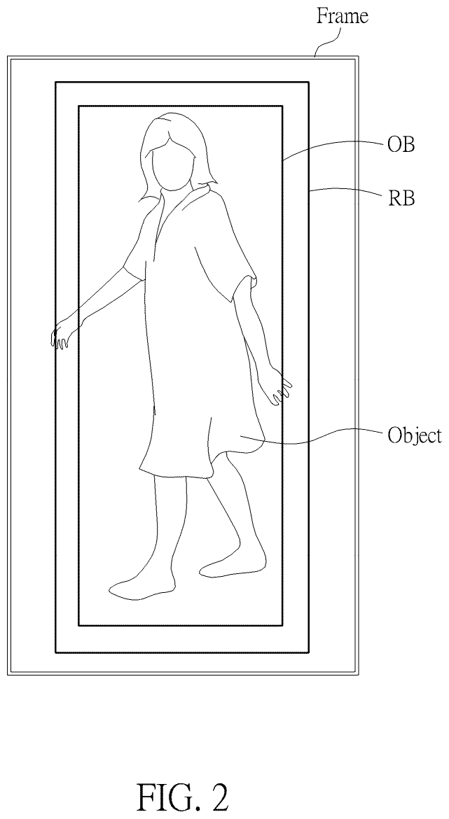

Therefore, after the motion signal of the image capturing device is detected in step 106, the background speed and the foreground speed of the current frame are determined. Please refer to FIG. 2, which is a schematic diagram of calculating a background speed according to an embodiment of the present invention.

Assume that the object in the frame is known, and the movement of the frame is detected. A frame line OB of FIG. 2 selects the object in movement; a frame line RB selects a circular region, which is an outer ring of the object in the current frame, wherein the circular region is related to a size of the object. In the embodiment of FIG. 2, the frame line OB and the frame line RB are all rectangles.

In order to calculate the background speed within the peripheral region of the object in the current frame, the circular region between the frame line RB and the frame line OB is defined as a peripheral region or a background region of the object, such that the speed of each block within the peripheral region of the frame line RB may be determined to calculate a background average speed of the object.

In addition, the present invention further determines whether each block of the circular region of the object in the current frame belongs to the background or not according to the background average speed.

In an embodiment, a conditional expression of the background determination may be:

Is_bg=((diff(current_speed, bg_speed_previous)>threshold)?0:1) (1)
wherein Is_bg denotes the conditional expression, threshold denotes a threshold, bg_speed_previous denotes the background speed of the previous frame, current_speed denotes a block speed of the current frame, diff denotes a difference between bg_speed_ previous and current_speed.

When a difference (diff) between the background speed (bg_speed_previous) and the block speed (current_speed) of the previous frame is larger than the threshold, the block is determined as not the background; when the difference (diff) between the background speed (bg_speed_previous) and the block speed (current_speed) of the previous frame is smaller than the threshold, the block is determined as the background.

In other words, whether each block belongs to the background or not may be determined according to the block speed current_speed of the current frame and the background speed corresponding to the previous frame, and the threshold is determined according to the object and the current frame.

Then, the background speed is updated according to a background block number of the circular region of the object in the current frame and a previous background speed and a previous block number of the object in the previous frame. In an embodiment, the background speed of each frame is:

w(bg_count)=count(is_bg)*(p/q) (2)

bg_speed_new=(bg_speed_previous*w(bg_count_previous)+bg_speed_curr*w(bg_count))/(w(bg_count_previous)+w(bg_count)) (3)
wherein count(is_bg) denotes the background block number of the current frame, p/q denotes a normalization parameter, w(bg_count) denotes a result of a normalized background block number of the current frame, bg_speed_new is the updated background speed of the object in the current frame, which is determined according to the previous background block number bg_count_previous and corresponding weighting value w(bg_count_previous) of the previous background block number of the previous frame, and the current background block number bg_count and corresponding weighting value w(bg_count) of the current background block number of the object in the current frame.

Notably, the background speed is not updated when the blocks within the circular region are not enough to determine the background speed.

On the other hand, the present invention determines whether each block of a plurality of blocks of the object in the current frame belongs to the foreground or not according to the selected blocks within the frame line OB, so as to determine the foreground speed of the object in the current frame.

In detail, in order to calculate the foreground speed of the object, a weighting average value of all blocks within the frame line OB of the object in FIG. 2 is determined, and then the blocks within the frame line OB and with similar speed to the background speed are eliminated. In addition, the block with the same speed with the background speed is given with a lower weight value.

A conditional expression for determining the weighting value W of each block speed is:

W={1, if a direction of the block speed is identical to that of the background speed, otherwise abs(speed-bg_speed)*k} (4)
wherein speed denotes the block speed, bg_speed denotes the background speed, k denotes a normalized positive parameter. When a direction of the block speed is identical to that of the background speed, the weighting value is equal to 1; otherwise, when the direction of the block speed is opposite to that of the background speed, the weighting value is larger than 1. In other words, the weighting value of each block of the frame line OB is determined according to a background moving direction and a foreground moving direction of the block.

Then, the object position of the object of the current frame is determined according to the background speed and the foreground speed of the current frame determined in step 106, the background speed and the foreground speed of the object of the current frame and the previous object position of the object in the previous frame determined in step 108.

More Specifically, the Previous Object Position May Be determined when the image capturing device is still, or determined by an artificial intelligence (AI) algorithm, which recognizes position of specific type objects. In another embodiment, when the image capturing device moves, the object position of the current frame may be estimated according to the object position of the previous frame and a moving speed, but not limited thereto.

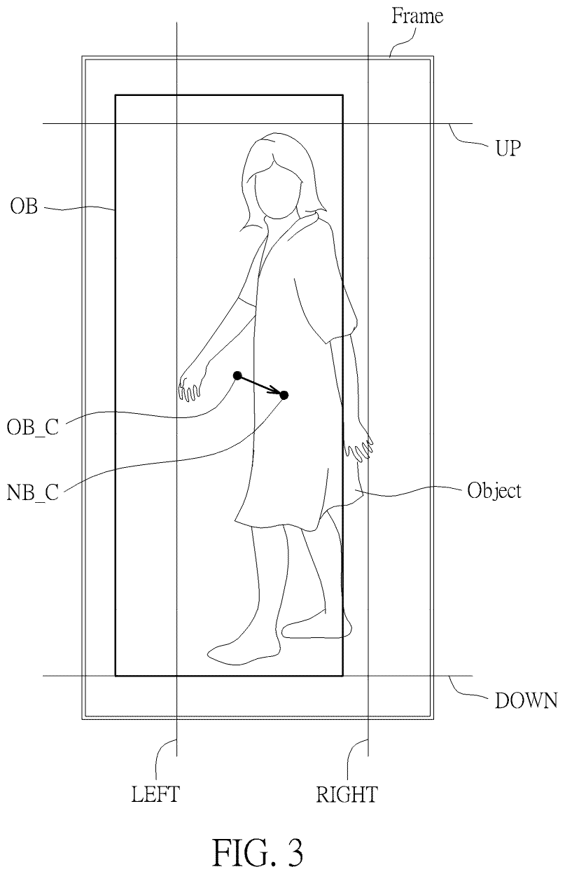

Since the object detection process 10 of the present invention is to precisely locate the object position when the image capturing device moves or when the frames captured by the image capturing device are moved. Please simultaneously refer to FIG. 3, which is a schematic diagram of updating an object position according to an embodiment of the present invention.

In order to update to the object position, the object detection process 10 determines a non-background speed region of the object in the current frame, and updates the object position according to a difference between a center point of the object and a center point NB_C of the non-background speed region. In this example, the non-background speed region is a rectangle, but not limited thereto.

As shown in FIG. 3, the non-background speed region is formed by line segments UP, DOWN, LEFT, RIGHT with the center point NB_C. The object detection process 10 may compare the center point NB_C of the non-background speed region and the center point OB_C of the frame line OB, and a displacement of the frame line OB may be determined according to the difference between the center points. In this way, the object detection process 10 according to an embodiment of the present invention may precisely update the object accordingly.

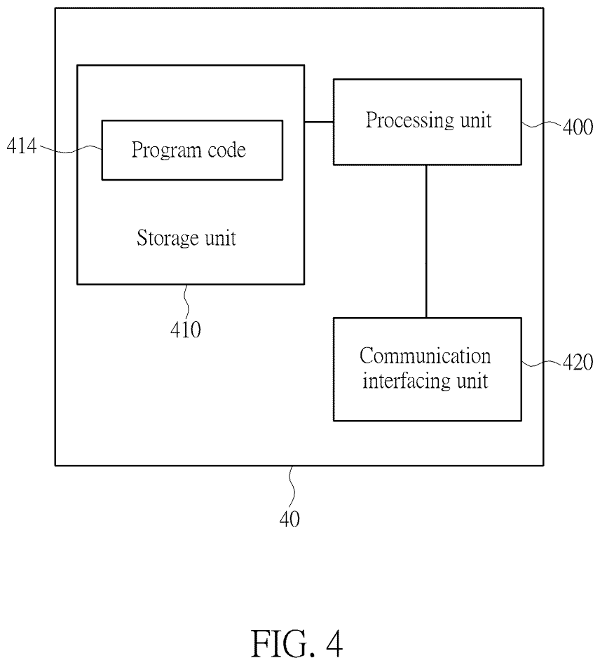

In addition, please refer to FIG. 4, which is a schematic diagram of a computer system 40 according to an example of the present invention. The computer system 40 may include a processing unit 400 such as a microprocessor or Application Specific Integrated Circuit (ASIC), a storage unit 410 and a communication interfacing unit 420. The storage unit 410 may be any data storage device that can store a program code 414. The processing unit 400 may read the program code 414 and perform the object detection process 10 of FIG. 1 based on the program code 414. Examples of the storage unit 410 include but are not limited to a subscriber identity module (SIM), read-only memory (ROM), flash memory, random-access memory (RAM), CD-ROM/DVD-ROM, magnetic tape, hard disk and optical data storage device.

Notably, the embodiments stated above illustrates the concept of the present invention, those skilled in the art may make proper modifications accordingly, and not limited thereto. For example, the size and the shape of the circular region, the range of the moving confidence value about determining whether the frame is moved or not, the weighting values of the background blocks and the foreground blocks may be modified according to different requirements of users and computer systems, and not limited thereto.

In summary, the object detection method and the computer system of the present invention separates moving objects and distinguishes the object and the background to precisely update the object position.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An object detection method, for an image capturing device comprising:
receiving a plurality of frames from the image capturing device;
calculating a background speed and a foreground speed of an object in a current frame of the plurality of frames, when detecting a motion signal of the image capturing device; and
determining an object position of the object in the current frame according to the background speed, the foreground speed of the object in the current frame and a previous object position of the object in a previous frame.

2. The object detection method of claim 1, wherein when the image capturing device is still, the image capturing device is configured to generate the motion signal according to a moving count value of a plurality of moving blocks of the current frame.

3. The object detection method of claim 2, wherein the moving count value is related to a ratio of the plurality of moving blocks to a plurality of blocks of the current frame.

4. The object detection method of claim 3, further comprising:
determining whether the image capturing device generates a moving confidence value of the motion signal or not, according to the ratio of the plurality of moving blocks to the plurality of blocks of the current frame.

5. The object detection method of claim 2, further comprising:
determining whether the image capturing device generates a moving confidence value of the motion signal or not, according to a difference of the moving count value of the plurality of moving blocks of the current frame and a previous moving count value of a plurality of moving blocks of the previous frame.

6. The object detection method of claim 1, wherein the step of calculating the background speed and the foreground speed of the current frame of the plurality of frames comprises:
calculating a background average speed of a circular region of the current frame;
determining whether each block of the circular region of the object in the current frame belongs to background or not according to the background average speed;
determining a block number of the circular region of the object according to whether the each block of the circular region belongs to the background or not; and
updating the background speed according to a background block number and a corresponding weighting value of the circular region of the object in the current frame and a previous background block number and a corresponding previous weighting value of the object in the previous frame.

7. The object detection method of claim 6, wherein the circular region is a peripheral region of the object in the current frame, and whether or not each block belongs to the background is determined according to a previous background speed of the previous frame.

8. The object detection method of claim 1, wherein the step of calculating the background speed and the foreground speed of the current frame of the plurality of frames comprises:
determining a weighting value for each block of a plurality of blocks of the object in the current frame; and
determining the foreground speed of the object in the current frame according to the weighting value and corresponding speed of the each block of the object.

9. The object detection method of claim 8, wherein the weighting value of the each block is determined according to a background moving direction and a foreground moving direction of the block.

10. The object detection method of claim 1, further comprising:
determining a non-background speed region of the object in the current frame; and
updating the object position of the object according to a difference between a center point of the object and a center point of the non-background speed region.

11. A computer system, comprising:
a processing device; and
a memory device coupled to the processing device, for storing a program code instructing the processing device to perform an object detection process in a video, wherein the object detection process comprises:
receiving a plurality of frames from an image capturing device;
calculating a background speed and a foreground speed of an object in a current frame of the plurality of frames, when detecting a motion signal of the image capturing device; and
determining an object position of the object in the current frame according to the background speed, the foreground speed of the object of the current frame and a previous object position of the object in a previous frame.

12. The computer system of claim 11, wherein when the image capturing device is still, the image capturing device is configured to generate the motion signal according to a moving count value of a plurality of moving blocks of the current frame.

13. The computer system of claim 12, wherein the moving count value is related to a ratio of the plurality of moving blocks and a plurality of blocks of the current frame.

14. The computer system of claim 13, wherein the object detection process comprises:
determining whether the image capturing device generates a moving confidence value of the motion signal or not, according to the ratio of the plurality of moving blocks and the plurality of blocks of the current frame.

15. The computer system of claim 12, wherein the object detection process further comprises:
determining whether the image capturing device generates a moving confidence value of the motion signal or not, according to a difference of the moving count value of the plurality of moving blocks of the current frame and a previous moving count value of a plurality of moving blocks of the previous frame.

16. The computer system of claim 11, wherein the step of calculating the background speed and the foreground speed of the current frame of the plurality of frames comprises:
calculating a background average speed of a circular region of the current frame;
determining whether each block of the circular region of the object in the current frame belongs to background or not according to the background average speed;
determining a block number of the circular region of the object according to whether the each block of the circular region belongs to the background or not; and
updating the background speed according to a background block number and a corresponding weighting value of the circular region of the object in the current frame and a previous background block number and a corresponding previous weighting value of the object in the previous frame.

17. The computer system of claim 16, wherein the circular region is a peripheral region of the object in the current frame, and whether or not each block belongs to the background is determined according to a previous background speed of the previous frame.

18. The computer system of claim 11, wherein the step of calculating the background speed and the foreground speed of the current frame of the plurality of frames comprises:
determining a weighting value for each block of a plurality of blocks of the object in the current frame; and
determining the foreground speed of the object in the current frame according to the weighting value and corresponding speed of the each block of the object.

19. The computer system of claim 18, wherein the weighting value of the each block is determined according to a background moving direction and a foreground moving direction of the block.

20. The computer system of claim 11, wherein the object detection process further comprises:
determining a non-background speed region of the object in the current frame; and
updating the object position of the object according to a difference between a center point of the object and a center point of the non-background speed region.
